(19) United States
(12) Patent Application Publication
(10) Pub. No.: US 2022/0010480 A1
(43) Pub. Date: Jan. 13, 2022

(54) Tag Identification System

(71) Applicant: Bob Barker Company, Inc., Fuquay-Varina, NC (US)

(72) Inventors: Gerrad Stephen Allison, Angier, NC (US); Melody Ballard, Fuquay-Varina, NC (US)

(21) Appl. No.: 17/371,599

(22) Filed: Jul. 9, 2021

Related U.S. Application Data
(60) Provisional application No. 63/113,303, filed on Nov. 13, 2020.
(60) Provisional application No. 63/050,254, filed on Jul. 10, 2020.

(51) Int. Cl. D06F 93/00; B65C 5/00; B31D 1/02

(52) U.S. Cl. CPC D06F 93/005; B31D 1/027; B65C 5/00

(57) ABSTRACT

The present application is directed to an identification system that is configured to be attached to an object. The identification system includes one or more tags that can be manipulated to uniquely identify the object. The manipulation can include removing one or more of the tags and/or marking one or more of the tags.

### RELATED APPLICATIONS

This application claims priority to U.S. Provisional Application No. 63/050,254, filed 10 Jul. 2020 and U.S. Provisional Application No. 63/113,303 filed 13 Nov. 2020, the disclosures of which are incorporated by reference herein in their entireties.

### BACKGROUND

There are various situations in which multiple people have a visually similar object. For example, a group of people may each have the same bag or the same towel. Each of these objects looks the same and it is difficult or not possible to visually identify the different objects when the objects are placed together. Thus, an identification system and method are needed to visually identify the objects in a group.

Once specific example of this problem is for objects that are given to persons in an institution, such as a prison, school, or hospital. Each of the objects has the same visual appearance. For example, a clothes bag given to each person looks visually the same. Likewise, towels given to each person look the same. When the objects are all placed together it is difficult or not possible for each user's object to be identified from the group. For example, a laundry bag in a washing machine with other laundry bags cannot be visually identified. This problem is further confounded as each laundry bag may hold the same clothes that are given to each person at the institution.

### SUMMARY

One aspect is directed to a method of visually identifying each individual object in a set of objects in which each of the objects has the same visual appearance. The method comprises attaching a set of tags to each of the objects at a common location on the objects with the set of tags being the same for each of the objects. The method also comprises for each of the objects: selecting a visually distinct combination of one or more of the tags with the visually distinct combination being different than the other objects; and removing the non-selected ones of the tags from the object with just the selected ones of the tags remaining attached to the object such that the object can be visually identified from the other objects in the set of objects.

In another aspect, the method comprises attaching the set of tags in a common configuration to each of the objects.

In another aspect, the method comprises attaching the set of tags in an overlapping configuration on each of the objects with a top one of the tags visually obscuring lower ones of the tags.

In another aspect, the method comprises removing the non-selected tags from each of the objects such that just a single one of the tags remains attached to each of the objects with the single remaining tag being different for each of the objects.

In another aspect, removing the non-selected tags from the object comprises cutting the non-selected tags off the object.

In another aspect, one or more of the tags in each of the set of tags comprise a plurality of zones that each comprises a different visual appearance with the method further comprising marking one or more of the zones for one of the objects and visually distinguishing the object from the other objects.

In another aspect, the method comprises forming a mark on one of the zones of the object with each of the plurality of zones being a different color.

In another aspect, the method comprises each of the objects being laundry bags that have an identical appearance and each of the tags comprising a fabric sheet.

One aspect is directed to a method of visually identifying each individual object in a set of objects. The method comprises attaching a common set of tags to each of the objects at a common location on each of the objects. For each of the objects, the method comprises creating a visually distinct identifier with one or more of the tags and removing one or more of the tags from the object that do not form a part of the visually distinct identifier.

In another aspect, creating the visually distinct identifier with one or more of the tags comprises selecting one or more of the tags with each of the tags having a different visual appearance than the other tags in the set of tags.

In another aspect, creating the visually distinct identifier with one or more of the tags comprises selecting one of the tags from the set of tags.

In another aspect, creating the visually distinct identifier with one or more of the tags comprises for each object marking one or more zones on one of the tags and altering the visual appearance of the one or more zones.

In another aspect, creating the visually distinct identifier with one or more of the tags comprises marking one or more zones on one of the tags with each of the zones being a different color.

In another aspect, the method comprises each of the objects being laundry bags that have an identical appearance and each of the tags comprises a fabric sheet.

One aspect is directed to an identification system for identifying a group of objects that have a common visual appearance. The identification system comprises a plurality of tags attached to the object in an overlapping configuration with each of the tags having a common shape and size and comprising a different visual appearance.

In another aspect, each of the objects comprises a laundry bag and each of the plurality of tags comprises a fabric sheet.

In another aspect, each of the tags has a unique color with the unique color not appearing on any of the other ones of the tags.

In another aspect, for each of the objects, each of the plurality of tags are attached with a common fastener.

In another aspect, each of the tags comprises a sheet with outer edges, a first face, and an opposing second face, with each of the tags attached to the object along one of the outer edges.

In another aspect, each of the tags comprises a plurality of zones spaced apart on the first face with each of the zones comprising a different visual appearance.

One aspect is directed to an identification system to identify an object. The identification system includes two or more tags attached to the same location on the object. Each of the tags includes the same shape and size with each of the tags being visually distinct.

In another aspect, the tags are attached to the object in an overlapping arrangement.

In another aspect, an upper one of the tags overlaps with and visually obscures lower ones of the tags.

In another aspect, each of the tags is a different color.

In another aspect, each of the tags includes outer edges, a first face, and an opposing second face, with each of the tags attached to the object along one of the outer edges.

One aspect is directed to an identification system to identify an object. The identification system includes an object with a body. Two or more tags are integrally formed with and extend outward from the body. Each of the tags includes the same shape and size with each of the tags being visually distinct.

One aspect is directed to a method of identifying each individual object in a set of objects. The method includes providing each of the objects with the same set of tags with each of the tags being visually distinct. The method includes selecting one tag for each object. The method includes removing the other non-selected tags from each object such that each object has a single tag remaining attached to the object.

In another aspect, each of the tags in the set includes a different color.

One aspect is directed to a method of identifying each individual object in a set of objects. The method includes providing each of the objects with the same set of tags. The method includes selecting a distinct combination of one or more tags for each object. The method includes removing the other non-selected tags from each object such that each object has the one or more combination of tags remaining attached to the object.

In another aspect, each of the objects has the same tags with each of the tags being visually distinct.

One aspect is directed to an identification system to identify an object. The system comprises a tag configured to be attached to the object. Two or more zones are positioned in a non-overlapping arrangement on the tag. Each of the zones comprises at least one unique visual feature to visually identify the zone.

In another aspect, the unique visual feature comprises a unique color.

In another aspect, the unique visual feature comprises a unique shape.

In another aspect, the unique visual feature comprises a unique indicia.

In another aspect, the tag comprises a front face and a rear face with the two or more zones on just one of the front and rear faces.

In another aspect, the two or more zones do not extend across the entirety of the tag.

One aspect is directed to an identification to identify an object. The system comprises a tag comprising a front face and a rear face. A plurality of zones are positioned on the front face. Each of the zones comprises at least one unique visual feature to visually identify the zone. Each of the zones comprises the same shape and size.

In another aspect, the zones are positioned directly adjacent to each other on the tag.

In another aspect, the unique visual feature comprises a unique color.

### BRIEF DESCRIPTION OF THE DRAWINGS

FIG. 1 is a front view of an object with an attached identification system that includes multiple visually distinct tags.

FIG. 1A is a close-up view of the tags of FIG. 1 with the tags in a downward position in an overlapping arrangement.

FIG. 2 is a schematic diagram of a tag.

FIG. 3 is a front view of an object with an attached identification system that includes multiple visually distinct tags.

FIG. 3A is a close-up view of the tags of FIG. 3 with the tags in a downward position and spaced apart on the object.

FIG. 4 is a flowchart diagram of a method of individually identifying each object from a group of objects.

FIG. 5 is a front view of an object with an identification system that includes multiple visually distinct tags.

FIG. 6 is a front view of a tag with multiple zones.

FIG. 7 is a front view of a tag with multiple zones.

FIG. 8 is a front view of a tag attached to an object.

FIG. 9 is a front view of a tag with a mark positioned in one of the zones.

### DETAILED DESCRIPTION

The present application discloses an identification system configured to be attached to an object. One or more tags are attached to each of the objects. The tags are configured to be manipulated to provide a unique appearance to allow for a user to visually identify the object. In one example, the identification system includes two or more tags that are visually distinct. One or more of the tags is removed from the object with a subset of the tags remaining attached. These remaining one or more tags are used to identify the object. In one specific example, just a single tag remains attached to identify the object. Other examples include two or more tags that remain attached to the object for identification. In another example, one or more tags that each include two or more zones are attached to the object. The zones can be marked to uniquely identify the object.

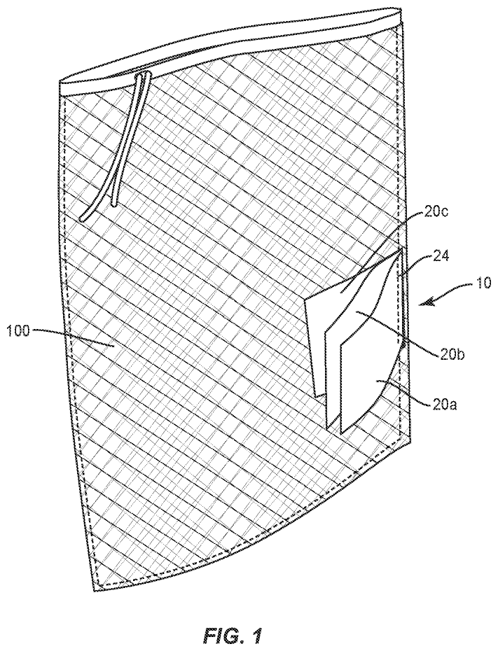

FIGS. 1 and 1A illustrate an identification system 10 with multiple tags 20 initially attached to an object 100. The number of tags 20 can vary depending upon the number of objects 100 that are to be identified. Each of the tags 20 is visually distinct from the other tags. In one example as illustrated, each of the tags 20 is a different color.

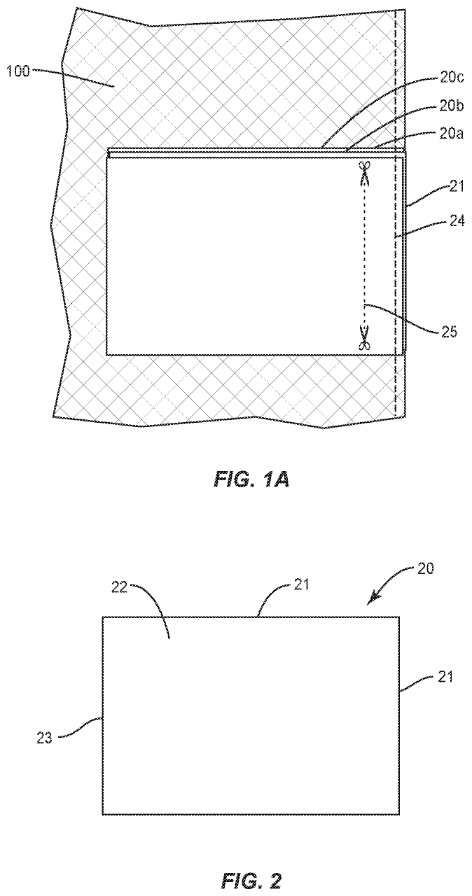

FIG. 2 schematically illustrates a tag 20 with a shape defined by outer edges 21. In this example, the tag 20 includes a rectangular shape. The tag 20 is a substantially flat sheet with a front face 22 and an opposing rear face 23. The tag 20 can be constructed from a variety of materials, including but not limited to various fabrics and plastic sheeting. In one example with the identification system 10 used to identify laundry bags 100, the tags 20 are constructed from a material that can withstand washing and drying without damaging clothes that are contained within the laundry bag 100.

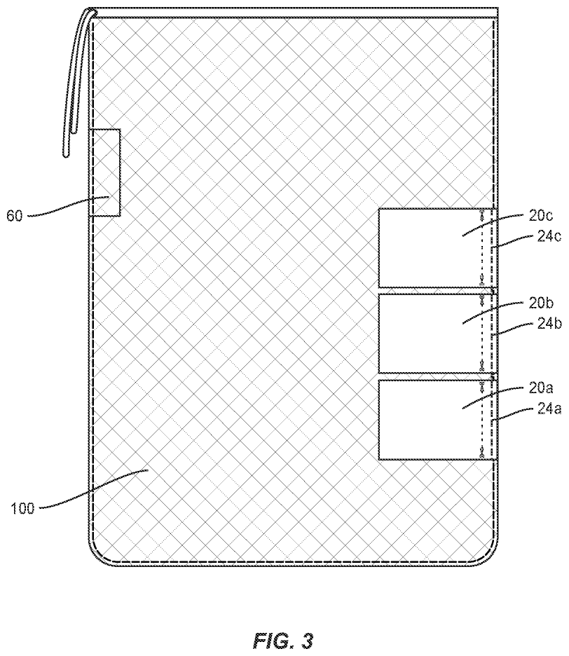

The tags 20 are attached to the object 100 with one or more fasteners 24. Various fasteners 24 can be used to attach the tags 20, including but not limited to a seam formed by thread, a mechanical fastener such as a rivet, adhesives, and combinations thereof. In one example as illustrated in FIGS. 1 and 1A, the fastener 24 includes a seam 24. A fastener 24 can connect one or more tags 20 to the object 100. As illustrated in FIG. 1A, a single seam 24 connects each of tags 20 to the object 100. In another example as illustrated in FIGS. 3 and 3A, each of the tags 20 is connected by different fasteners 24. The fasteners 24 can connect to different sections of the tags 24. In one example, the fastener 24 extends along one of the outer edges 21. In another example, a fastener 24 extends through an interior section of a tag 20 (i.e., away from an outer edge 21).

Each of the tags 20 is visually distinct to identify the object. The visual differences between the tags 20 are caused by one or more different aspects. The aspects can include but are not limited to color, shape, and indicia.

In one example, each tag 20 is a different color. This can include the entirety of the tag 20 being a predetermined color, or one or more limited sections with the predetermined color. In one example, the entire tag 20 including both faces 22, 23 is a single color. In another example, the color is on just one face 22, 23, such as the upward face. In another example, just a portion of one or both faces 22, 23 include the color.

Another aspect includes each of the tags 20 with a different shape. The outer edges 21 are configured in a manner to form the shape. Examples of shapes include but are not limited to rectangular, circular, oval, and various non-uniform shapes.

Another aspect includes each of the tags 20 with different indicia on one or both faces 22, 23. Examples of indicia include but are not limited to alpha-numeric characters, words, symbols, patterns, and drawings. The indicia can extend across the entirety or limited sections of one or both faces 22, 23.

In another example, the tags 20 include two or more different aspects in combination to provide a visually distinctive appearance. One or all of the aspects are different than the other tags. For example, each tag 20 includes a different color and a different shape. In another example, each tag 20 includes a different color and different indicia. In another example, two or more different tags 20 include the same color, but each of these tags 20 has a different shape. The different combinations provide for accommodating a larger group of objects 100.

Each tag 20 can also include a removal location 25 indicating where the unused tags 20 are to be removed from the object 100. In one example as illustrated in FIGS. 1A and 3A, the removal location 25 is indicia (i.e., a dashed line and scissors image) indicating where the tag 20 is to be cut to remove it from the object 100. In another example, the removal location 25 can be scored, perforated, or otherwise weakened such that a user can remove the unused tags.

The fasteners 24 are configured and positioned such that the removal location 25 can be separated from the object 100 during removal. For example, the removal location 25 can be positioned away from the fastener 24 such that the tag 20 can be pulled away from the object 100 and cut at the removal location 25 without cutting or otherwise damaging the object 100. In one example, the removal location 25 coincides with a fastener 24 such that removal of the fastener 24 removes the tag 20 from the object 100.

The tags 20 can be attached to the various locations on the object 100 and in various manners. In one example as illustrated in FIGS. 1 and 1A, the tags 20 are attached to the object 100 in an overlapping arrangement at a single location. A single fastener 24 attaches each of the tags 20 to the object 100. The overlapping arrangement provides for the upper-most tag 20 to extend over the remaining tags 10.

In one example as illustrated in FIG. 1A, the size and shape of each tag 20 is substantially the same. This results in the top-most tag 20 visually obscuring the lower tags 20. In another example, two or more of the tags 20 include the same shape with different sizes.

In another example as illustrated in FIGS. 3 and 3A, the tags 20 are spread out at different locations on the object 100 (i.e., in a non-overlapping arrangement). Each tag 20 is attached with a separate fastener 24.

The number of tags 20 in the identification system 10 can vary. In one example, the number of tags 20 is equal to the number of different objects 100 in the group. For example, an identification system 10 would include seven tags 20 is used to identify seven different objects 100. This provides for each object 100 to be identified by a single different tag 20.

The identification system 10 can be used to identify a variety of different objects 100. The objects 100 are each visually the same such that it is not possible or at least difficult to visually determine the different objects 100. In one example as illustrated in FIGS. 1, 1A, 3, and 3A, the object 100 is a laundry bag 100 from a large number of other laundry bags. Except for the identification system 10, the objects 10 are visually the same. In another example, the identification system 10 identifies a clothing item, such as a shirt or pants.

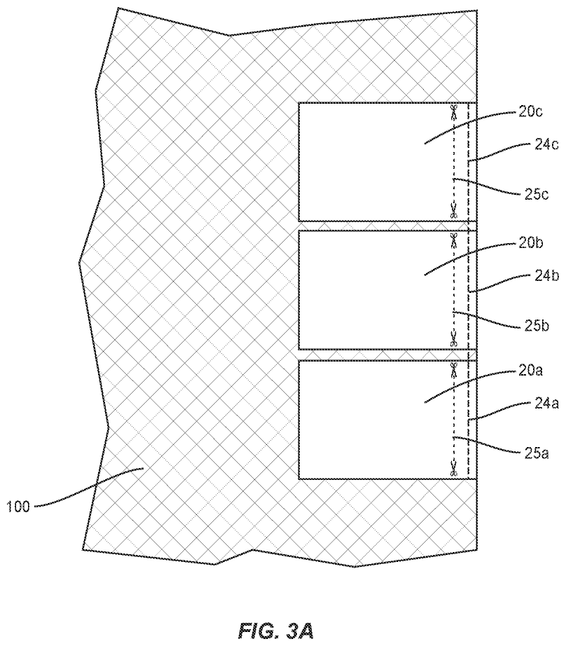

FIG. 4 illustrates one example of using the identification system 10. Multiple objects 100 that are visually indistinct each include an identification system 10 with multiple tags 20 (block 200). Each of the objects 100 includes the same identification system with the same tags 20.

In one example, the identification system 10 is positioned at the same one or more locations on each of the objects 100. In another example, the identification system 10 is positioned at different locations on two or more of the objects 100 in the group.

For the first object 100, a tag 20 is selected to identify the object 100 (block 202). The selected tag 20 is different than any of the other objects 100. The other tags 20 that are attached to the object 100 are removed (block 204). This results in just the selected tag 20 remaining attached to the object 100. The selected tag 20 is then used to identify the object 100.

The selection and removal process repeats for each object in the group (block 206). If there are no additional objects 100, the process is complete with each object 100 being identified by a visually different tag 20 (block 208). The objects 100 can then be used together and be visually identified based just on the identification system 10 that is now unique to each object 100.

In one example, a single tag 20 remains on each object 100 to identify the object 100. In another example, two or more tags 20 remain on the object 100 for identification. When multiple tags 20 remain on the object 100, the various combinations are different than the other objects 100 in the set of objects such that each is visually distinct. Leaving multiple tags 20 on the objects 20 can further increase the number of different tag combinations and thus allow for the identification system 10 to be used on larger sets of objects 100.

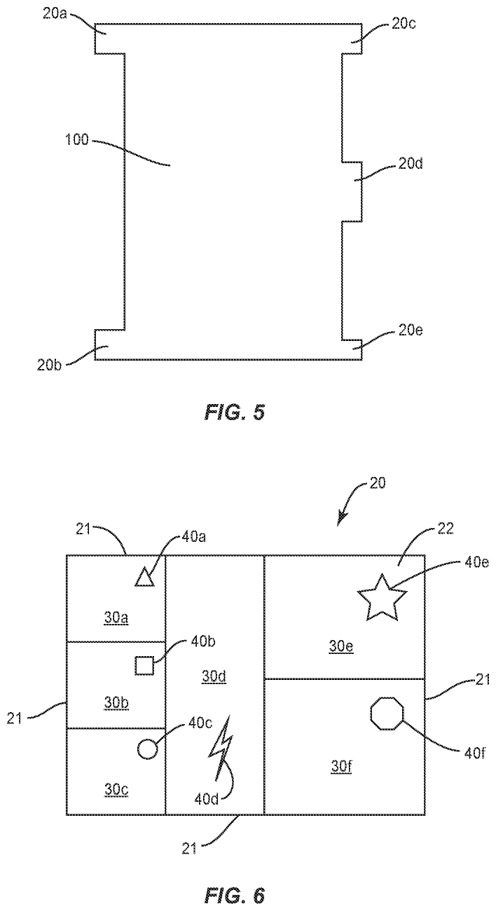

In another example, the tags 20 include two or more zones 30 as illustrated in FIG. 6. Each zone 30 includes one or more features 40 that are visually distinct from the other zones 30. A user marks one or more of the zones 30 to identify the object 100.

Each zone 30 includes one or more features 40 that cause the zone to be visually distinct from the other zones 30. The features 40 can include but are not limited to size, shape, color, and indicia. In one example, each zone 30 is identified by a single differentiating feature 40. In another example, one or more of the zones 30 is identified by two or more different features 40. The different zones 30 on the tag 20 can include the same or different number of features 40. The zones 30 are positioned on one or both of the front face 22 and the rear face 23. In one example, the zones 30 are positioned on one of the faces 22, 23 and the opposing face is blank. The zones 30 can extend over an entirety or one or more limited sections of the faces 22, 23.

FIG. 6 illustrates an example of a tag 20 that includes multiple zones 30a-30f. Each zone 30a-30f includes one or more different features 40a-40f. In this example, the features 40a-40f are different shaped indicia that are printed or otherwise formed in the zone 30. The different shapes in this example include triangle, rectangle, circle, zig-zag, star, and octagon.

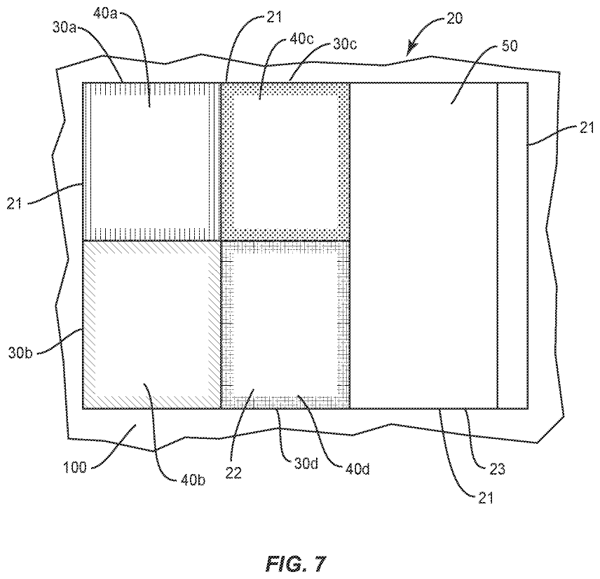

FIG. 7 includes an example of a tag 20 with four different zones 30a-30d. The zones 30a-30d each include the same size and shape. The differentiating feature 40 of each zone 30 is the color of the zone 30. Zone 30a includes a first color 40a (e.g., blue), zone 30b includes a different second color 40b (e.g., red), zone 30c includes a different third color 40c (e.g., black), and zone 30d includes a different fourth color 40d (e.g., orange).

One or more of the zones 30 can also include multiple different features 40. The various different features 40 can be combinations of various aspects, including but not limited to indicia, shape, and color.

In some examples, a group of two or more zones 30 can share common features 40 and also have unique features. FIG. 6 includes an example in which each zone 30 includes a unique first feature 40 that includes different shaped indicia. The zones 30 are further divided into groups that have a second feature 40 that includes the shape of the zones 30. Zones 30a-30c each include a first shape and size, zone 30d includes a different second shape and size, and zones 30e-30f include a third shape and size. Although some of the zones 30 include the same shapes, this can still be used to help differentiate the different zones 30 when used in combination with the different shaped indicia features 40.

The tag 20 can also include a band 50 having a different color than the zones 30 as illustrated in FIG. 7. The band 50 can be used to write information about the object 100 or other information. In one example, the rear face 23 includes the same color as the band 50 and can also be used to write information.

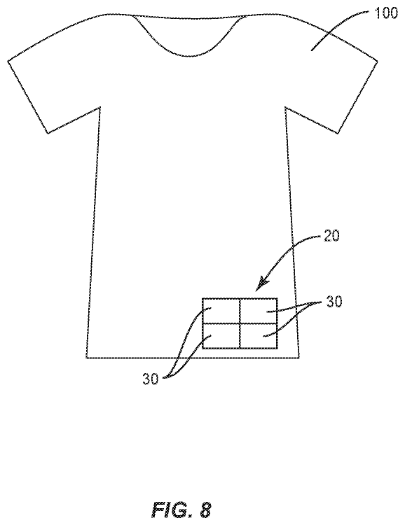

In one example, a single multi-zone 30 tag 20 is attached to the object 100. FIG. 8 illustrates an example of a tag 20 attached to the object 100 (e.g., shirt). One or more of the zones 30 can be marked to identify the object 100. In another example, two or more multi-zone tags 20 are attached to the object 100. The different tags 20 can be the same or different. The multiple tags 20 provide for additional combinations of marked zones 30 that can be used to identify the object 100.

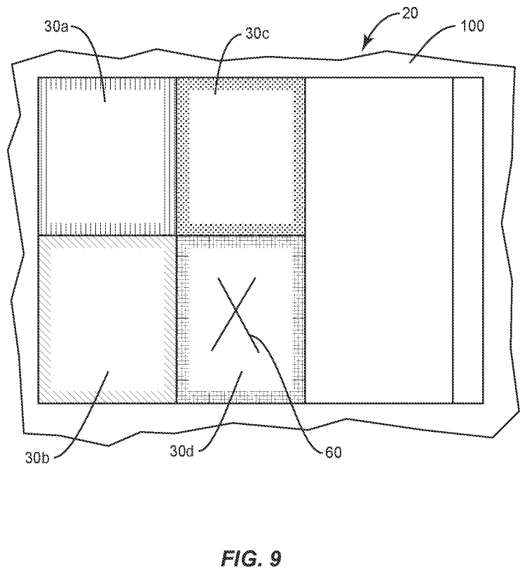

The zones 30 can be marked in a variety of different manners. This can include but is not limited to marking with a marker, pen, or like device, attachment of a fastener such as a pin or clamp, and removal of a section of the zone from a remainder of the tag 20. FIG. 9 includes an example a tag 20 that is marked to identify the object 100. In this example, a mark 60 is positioned in one of the zones (e.g., zone 30d) to identify the object 100.

One method of using the tags 20 includes attaching a tag 20 to each object 100. For each object 100, a different zone 30 or combination of zones 30 are indicated by one or more marks 60. All of the objects 100 can then be placed together and visually identified based on the visual marks 60.

One specific method includes attaching a tag 20 to each object 100. The tags 20 include at least the same or more zones 30 as there are objects 100. For example, if there are five objects 100 to be identified, the tags 20 include five or more zones 30. A mark 60 is placed on a different zone 30 or combination of zones 30 for each object 100. Thus, after the objects 100 are placed together they can be visually identified by the position of the marks 60 on the zones 30.

In one example, the multi-zone 30 tags 20 can be used in combination with the removal tags 20 described in FIGS. 1-4. This can include attaching one or more removal tags 20 and multi-zone tags 20 to the object 100.

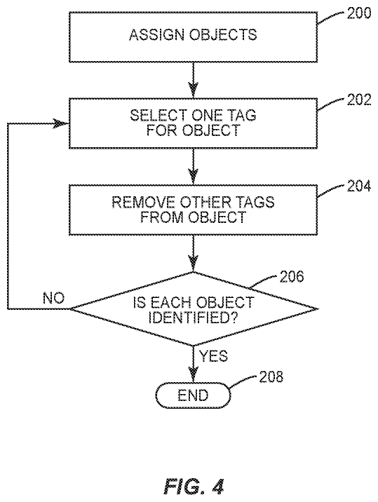

In some examples disclosed above, the tags 20 are attached to the object 100 with one or more fasteners 24. In other examples, the tags 20 are integrally formed with the object 100. In one example, the tags 20 include the same construction as the object 100. In other examples, the tags 20 have a different construction. FIG. 5 illustrates an example of an object 100 such as a towel. One or more tags 20 are integrally formed with the towel. The tags can include the same construction. The integral formation prevents the requirement for a fastener 24 to attach the tag 20 to the object 100. In one example, the tags 20 do not form a functional part of the object 100 but merely are added as the identification system 100. FIG. 5 illustrates an example with the tags 20 being extension of the main towel body. The tags 20 can be removed from the object 20 as described above leaving at least one tag 20 attached to identify the object 100.

In one specific example, the identification system 10 is used to identify laundry bags 100. In a specific application, the laundry bags 100 are used for washing the clothes of persons that are within a correctional facility, such as a prison, jail, juvenile detention facility, work camp, and rehabilitation center. In one specific example, there are ten persons that are each assigned a laundry bag 100. The identification system 10 includes one or more tags 20 attached to each of the laundry bags 100. For each laundry bag 100, the tag 20 is manipulated to identify the laundry bag 100. Thus, each laundry bag 100 is now individually identifiable based on the specific visually distinct one or more tags 20. The laundry bags 100 can then be used by each of the persons.

In one example with the object 100 being a towel, each of the towel and tags 20 include a 100% cotton construction with the same weave pattern. Each of the tags 20 includes the same shape and size.

The tags 20 can be constructed from a material to be positioned against the object 100, such as lying flat against the object 100. This prevents or reduces the chances of the tags 20 interfering with the use of the object 100.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method of visually identifying each individual object in a set of objects in which each of the objects has the same visual appearance, the method comprising:
attaching a set of tags to each of the objects at a common location on the objects with the set of tags being the same for each of the objects;
for each of the objects:
selecting a visually distinct combination of one or more of the tags with the visually distinct combination being different than the other objects; and
removing the non-selected ones of the tags from the object with just the selected ones of the tags remaining attached to the object such that the object can be visually identified from the other objects in the set of objects.

2. The method of claim 1, further comprising attaching the set of tags in a common configuration to each of the objects.

3. The method of claim 2, further comprising attaching the set of tags in an overlapping configuration on each of the objects with a top one of the tags visually obscuring lower ones of the tags.

4. The method of claim 1, further comprising removing the non-selected tags from each of the objects such that just a single one of the tags remains attached to each of the objects with the single remaining tag being different for each of the objects.

5. The method of claim 1, wherein removing the non-selected tags from the object comprises cutting the non-selected tags off the object.

6. The method of claim 1, wherein one or more of the tags in each of the set of tags comprise a plurality of zones that each comprises a different visual appearance, the method further comprising marking one or more of the zones for one of the objects and visually distinguishing the object from the other objects.

7. The method of claim 6, further comprising forming a mark on one of the zones of the object with each of the plurality of zones being a different color.

8. The method of claim 1, further comprising each of the objects being laundry bags that have an identical appearance and each of the tags comprising a fabric sheet.

9. A method of visually identifying each individual object in a set of objects, the method comprising:
attaching a common set of tags to each of the objects at a common location on each of the objects;
for each of the objects:
creating a visually distinct identifier with one or more of the tags; and
removing one or more of the tags from the object that do not form a part of the visually distinct identifier.

10. The method of claim 9, wherein creating the visually distinct identifier with one or more of the tags comprises selecting one or more of the tags with each of the tags having a different visual appearance than the other tags in the set of tags.

11. The method of claim 9, wherein creating the visually distinct identifier with one or more of the tags comprises selecting one of the tags from the set of tags.

12. The method of claim 9, wherein creating the visually distinct identifier with one or more of the tags comprises for each object marking one or more zones on one of the tags and altering the visual appearance of the one or more zones.

13. The method of claim 9, wherein creating the visually distinct identifier with one or more of the tags comprises marking one or more zones on one of the tags with each of the zones being a different color.

14. The method of claim 9, further comprising each of the objects being laundry bags that have an identical appearance and each of the tags comprises a fabric sheet.

15. An identification system for identifying a group of objects that have a common visual appearance, the identification system comprising:
a plurality of tags attached to the object in an overlapping configuration with each of the tags having a common shape and size and comprising a different visual appearance.

16. The identification system of claim 15, wherein each of the objects comprises a laundry bag and each of the plurality of tags comprises a fabric sheet.

17. The identification system of claim 15, wherein each of the tags has a unique color with the unique color not appearing on any of the other ones of the tags.

18. The identification system of claim 15, wherein for each of the objects, each of the plurality of tags are attached with a common fastener.

19. The identification system of claim 15, wherein each of the tags comprises a sheet with outer edges, a first face, and an opposing second face, with each of the tags attached to the object along one of the outer edges.

20. The identification system of claim 19, wherein each of the tags comprises a plurality of zones spaced apart on the first face with each of the zones comprising a different visual appearance.
